(19) United States
(12) Patent Application Publication
(10) Pub. No.: US 2019/0281422 A1
(43) Pub. Date: Sep. 12, 2019

(54) MESSAGE DISPLAY APPARATUS AND METHOD

(71) Applicant: Wrinkl, Inc., Sands Point, NY (US)

(72) Inventor: Marc A. COHEN, Blue Bell, PA (US)

(21) Appl. No.: 15/916,930

(22) Filed: Mar. 9, 2018

(51) Int. Cl. H04W 4/12; H04L 12/58

(52) U.S. Cl. CPC H04W 4/12; H04L 51/16; H04L 51/04; H04L 51/38

(57) ABSTRACT

A method of displaying messages on a display device comprises the steps of: a) displaying on the display device a first plurality of messages including a first new message exchanged in a first messaging channel while at least partially preventing display of a second plurality of messages exchanged in a second messaging channel; b) detecting receipt of a second new message of the second plurality of messages without displaying the second plurality of messages in the second messaging channel; c) providing a physical indication of the detecting; d) enabling interaction with the display device; and e) displaying the second message in said second channel responsive to said interaction.

### FIELD OF THE INVENTION

The present invention relates to computer messaging and more particularly to management thereof. In particular, an apparatus and method are disclosed for improving computer operational efficiency through message management.

### BACKGROUND OF THE INVENTION

Electronic communication, including messaging, provides a very efficient manner of information exchange. In such forms of electronic communication, messages are exchanged between multiple parties in order to convey information. In one known form of messaging, two users operate respective client devices and effectively engage in conversation by transmitting messages between each other. Such communication may be in the form of a single continuous stream of back and forth messaging. Also, in some situations, more than two users (operating, for example, more than two respective client devices) may be communicating in a single continuous stream. While a single stream of messages may be transmitted in an ongoing sequence, it is also possible to have multiple channels, each with their own respective stream of messages.

A “conversation” of messages may be short or it may occur over an extended period of time. Such a period of time can last for hours, days, or even years. During the process of such a conversation, a large quantity of messages may be transmitted between multiple users. Typically, in order to identify and review a previously unseen message or messages within a stream of messages within a channel or channels, it may be desirable to scroll or somehow visually traverse through a list of channels until a channel containing a new or previously unseen message is located.

### BRIEF DESCRIPTION OF THE DRAWINGS

FIG. 1 is a block diagram that illustrates an exemplary network with associated computing devices in accordance with an exemplary embodiment of the present invention.

FIG. 2 is a block diagram that illustrates details of an exemplary client device in accordance with an exemplary embodiment of the present invention.

FIG. 3 illustrates an exemplary interface portal of a client device in accordance with an exemplary embodiment of the present invention.

FIG. 4 is a block diagram that illustrates multiple channels, each with respective messages.

FIGS. 5a, 5b and 5c are screenshots that illustrate user interfaces for viewing channels in accordance with exemplary embodiments of the present invention.

FIG. 6 is a flowchart diagram that illustrates steps for displaying messages in accordance with an exemplary embodiment of the present invention.

FIG. 7 is a flowchart diagram that illustrates in greater detail exemplary steps associated with a step illustrated in FIG. 6 in accordance with an exemplary embodiment of the present invention.

FIG. 8 is a further flowchart diagram that illustrates in greater detail further exemplary steps associated with a step illustrated in FIG. 6 in accordance with an exemplary embodiment of the present invention.

### SUMMARY OF THE INVENTION

A method of displaying messages on a display device comprises the steps of: a) displaying on the display device a first plurality of messages including a first new message exchanged in a first messaging channel while at least partially preventing display of a second plurality of messages exchanged in a second messaging channel; b) detecting receipt of a second new message of the second plurality of messages without displaying the second plurality of messages in the second messaging channel; c) providing a physical indication of the detecting; d) enabling interaction with the display device; and e) displaying the second message in said second channel responsive to said interaction.

### DETAILED DESCRIPTION

The present invention relates to messaging and in particular to the ability to display messages in channels that may be partially or completely obscured from view. With regard to messaging, what is referred to is the ability for one or more users to provide a series of messages. Messages typically occur in a stream, wherein each message comprises data. The data included in messages is often text, but this is merely exemplary as messages can include other content, including possibly any kind of data (e.g. audio, video, animation, graphics, web links, photos, file attachments, etc.).

Messaging (such as chat messaging) has become a very popular form of electronic communication due to its affordability and ease of use. On any given day, users may exchange numerous messages regarding a diverse range of topics. The users may use the messages to discuss, for example, group activities, to solicit opinions about various topics, or simply exchange short conversations with friends or co-workers.

A chat message session, as used herein, refers to a series of messages that are exchanged between one or more users, wherein for more than one user the users are in a group of users. When one of the users in the group adds a new message to a chat message session, the new message is sent to other users in the group. For example, if a first user adds a new message to the chat message session between three users in a group, then the new message may be sent to other selected users of the group, such as the second user and/or the third user. Thus, the chat message session may simulate a real-life conversation because users may communicate to the group at large, or to a specific person or a subset of the people in the group.

Such communication may take place within channels. Generally speaking, a channel permits a group of users to communicate. Group users assigned to a channel may communicate with each other and exchange messages with each other. Such exchange may occur as a message stream—as each group member sends a message to the group, the messages appear as a continuous sequence of messages, for example, in chronological order. This is merely one example of how group messaging may occur. Users in one exemplary embodiment of the invention may communicate with each other in a channel because they are permitted to do so. A user who is not permitted to communicate with other users in a channel is prevented from communicating in that channel.

To be more specific, and in one exemplary embodiment of the present invention, a channel may be defined as a virtual or digital “place” within a group messaging network where channel members conduct a group messaging discussion. Channels are organized around a topic, department, project, task, client or by using other criteria. Channels with more than two members are called “group channels.” Channels with just two members are called “direct message channels” or “DM channels.” A channel may have just one member, in which he or she sends reminders and other messages to self. Channels can be “private” or “public.” Private channels membership is by invitation of the channel creator and/or network admin(s). Public channels may be joined by all individuals included in the network (or, alternatively, by all of one or more classes of such individuals (e.g., Class A, but not Class B)). Alternatively, all network-included individuals, or any class(es) of network-included individuals, can be joined automatically as public channel members.

In an exemplary embodiment of the present invention, multiple channels exist. Each channel may include an exchange of messages between a respective group (one or more users) of users. Thus, for example, each channel may include its own respective “conversation” of messages. A user may be authorized to communicate within multiple channels. In each channel that the user is authorized to communicate, the group of other users that are permitted to communicate may be respectively different (although this is not a requirement). If a user is User A, one channel may permit communication between Users A, B and C, while another channel may permit communication between users A, D, and E.

As a further alternative, Users A, B and C may be permitted to communicate in one channel while Users A, B, C and D may be permitted to communicate in another channel.

As a further alternative, Users A, B and C may be permitted to communicate in one channel while Users D, E, and F may be permitted to communicate in another channel.

In a further alternative, Users A, B and C may be permitted to communicate in two channels.

The manner in which channels are displayed may make it difficult to see the “conversation” taking place in multiple channels. While multiple channels may be displayed on one screen simultaneously, screens have limited real estate and there is a practical limit to how many channels may be viewed (or at least partially viewed) at once. On a smartphone screen, for example, while a user is communicating with others in a channel, only that channel can be viewed. When using a laptop or tower, larger screens are typically used and more than one channel may be viewed at a time, but there are still practical limits to the maximum that can be viewed (or partially viewed) at once.

Smartphones try to deal with the issue of multiple channels by offering a screen in which the channels that have most recently had activity are displayed. While multiple channels are displayed, the screen real estate imposes a limit on how many channels are visible at once. Also, only a limited quantity of the contents of each channel may be displayed. In some implementations, only a few words of the most recent message in each channel may appear.

The smartphone solution thus has inherent limitations. Furthermore, in some situations, the number of channels that a user may have access to may be immense. For example, it is possible for a user to have access to over one thousand channels. In such a situation, changing display from one channel to another channel may be very challenging.

The situation may be further compounded as new messages enter channels. If there are hundreds or thousands of channels receiving new messages, viewing and responding to many messages on many channels may be time consuming, confusing, and inefficient. When limited channel portions (and/or numbers of channels) are visible, even knowing when a new message has arrived on a particular channel may be difficult to detect.

To further complicate matters, new messages may simply land in a user's channels in the order in which they are received. In such a situation, the user may struggle to view messages in channels with higher priority before viewing messages in channels with lower priority.

The inventor of the present application has invented a method and apparatus for displaying messages that are received in multiple channels.

In one implementation, a computer program product may be installed and/or a service may be selected from a cloud-computing environment in order to obtain the benefits of the techniques described herein. In an implementation, the computer program product may be downloaded onto a client device. For example, a user may elect to download the computer program product from a service associated with an online server. The client device may transmit a request for the computer program product over a network and, in response, receive the computer program product from the service. The computer program product may be installed locally on the client device or stored at the service and may be accessed through the client device, for example, via a mobile web browser. In one exemplary embodiment, software to achieve the above results is stored in a cloud computing environment. In another exemplary embodiment, the software is stored in local client devices. In a further exemplary embodiment of the present invention, the software is stored in a combination of a cloud computing environment and (one or more) local client device(s).

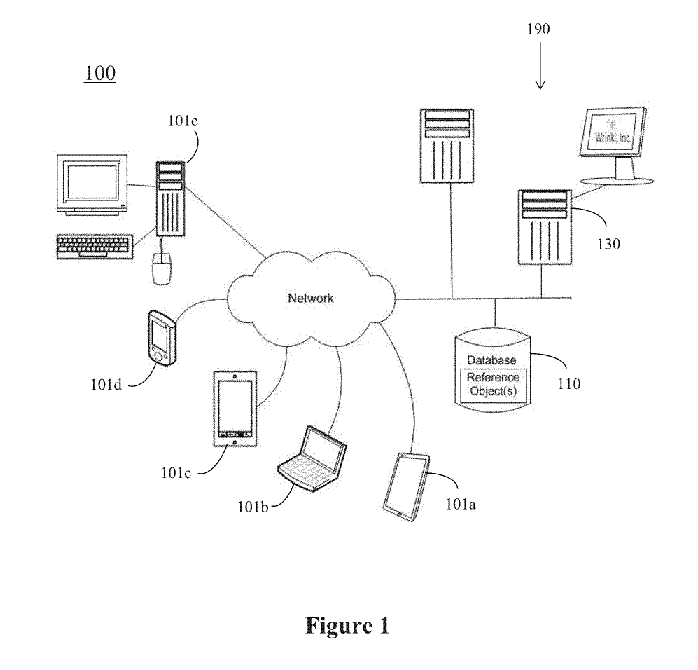

FIG. 1 is a block diagram that illustrates an exemplary network with associated computing devices in accordance with an exemplary embodiment of the present invention. In an exemplary embodiment of the present invention, two or more computing devices (e.g., client devices) may engage in an electronic communication session (e.g., chat session) with each other. In some implementations, a first participant/client device may engage in a chat session with a second participant/client device via a network. As shown, communications network 100 includes a plurality of computing devices such as client devices 101a-101e which may include for example, a base station, a personal data assistant (PDA), a laptop/netbook and a tablet as well as computing server devices and (e.g., computing devices that can be located at a number of different receiving stations). The various devices may be interconnected via a network or direct connection and/or may be coupled via a communications network (e.g., a LAN, WAN, the Internet, etc. that may be wired or wireless). In some implementations, the computing devices may communicate with each other before accessing the communication network. In some implementations, the network may include a database running on or in communication with the server device and/or the client devices or some combination thereof. Server 190 includes computing device 120, computing device 130, a terminal for data input and/or display, etc. Communication may occur via network 140. While client devices such a devices 101a and 101b are shown, it is understood that fewer or more client devices such as client devices 101x and 101z (not shown) may also be included). Memory for storing data that is useful in accordance with an exemplary embodiment of the present invention may be included in the form database 110.

The above description is with regard to at least two users (or more) communicating with each other with respective client devices. In a further exemplary embodiment of the present invention, the “first message” and the “second message” are both entered into the same computing device. In a further exemplary embodiment of the present invention, further messages may or may not be included from a source outside of the computing device from which the “first message” and “second message” are entered. In yet another exemplary embodiment of the invention, a single user may enter the “first message” on one computing device and the “second message” on another computing device.

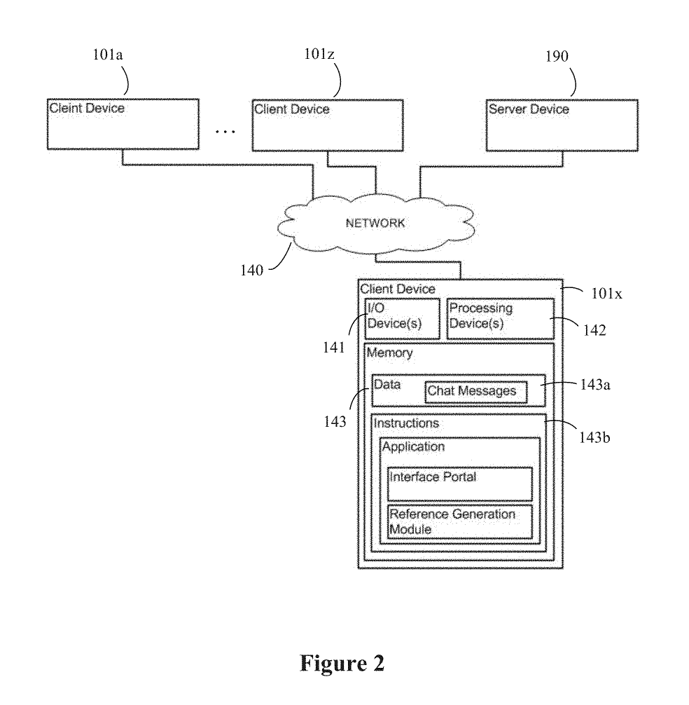

FIG. 2 is a block diagram that illustrates details of an exemplary client device in accordance with an exemplary embodiment of the present invention. In one or more exemplary embodiments of the present invention, the system may facilitate the transfer of electronic communications between computing devices of two or more users or participants over a communication network. The system can include one or more servers (e.g. a server device), which provide access or a communication link between a plurality of client devices in order to facilitate communication between two or more client devices over a network. In some implementations, the system may include an interface portal that provides for the display of network content, such as chat messages of a chat message session or any other type of network data received in response to a transmitted chat message.

FIG. 2 illustrates a plurality of client devices 101a-101z. In an exemplary embodiment of the present invention, features of the invention may be included on a server 190 (shown in FIG. 1) or on a client device 101a-101z. Exemplary client device 101x is illustrated. Client device 101x may include I/O device driver(s) 141 (and/or related database structures), processing device(s) 142 (and/or related database structures) and memory 143. Memory 143 may include data memory 143a and instruction memory 143b.

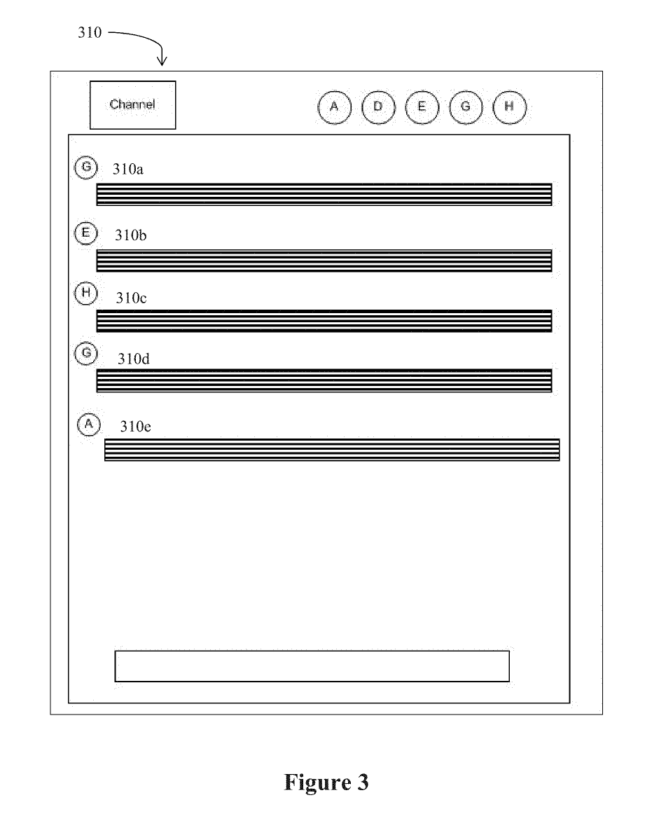

FIG. 3 illustrates an exemplary interface portal 310 of a client device 101x in accordance with an exemplary embodiment of the present invention. The interface portal provides an example interface in which a chat messaging session can be engaged by a number of users that are represented by the participant icons 310a-310e on the portal. In some implementations, the interface portal may include several panels that include a channel/dialog panel that displays the different chat session groups that a particular user has joined. The interface portal displays a plurality of chat messages exchanged by the users. In some implementations, the interface portal includes a message window panel that may include a count of the current participants and a text entry region that allows the participants to insert and reformat the text (i.e., bold, italics, color), add a link (hypertext link) or other type of data into a chat session. Each message that is entered into the text entry region is displayed in the message window panel. In some implementations, the messages can be augmented with one or more references to a previous message in the chat session.

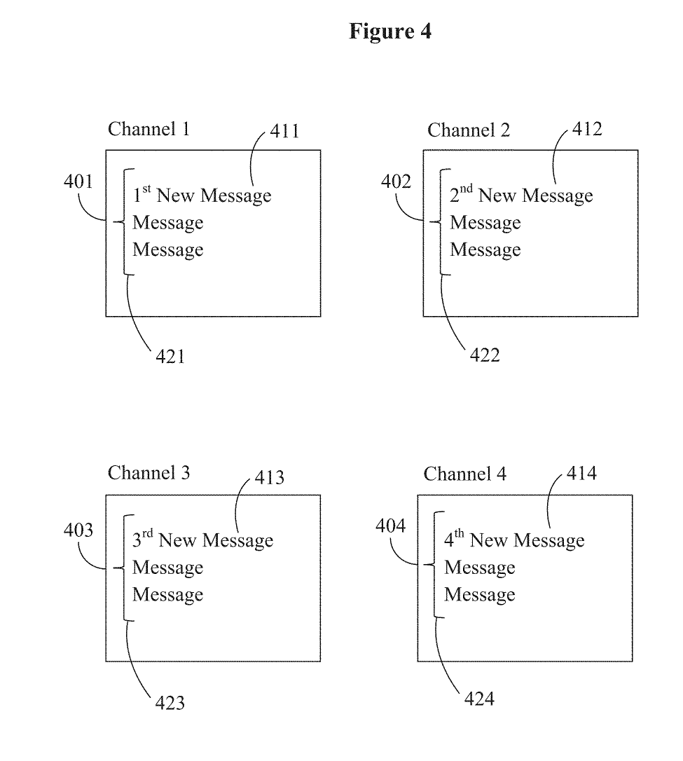

FIG. 4 is a block diagram that illustrates multiple channels in accordance with an exemplary embodiment of the present invention. In FIG. 4, four channels are illustrated, although this is merely exemplary. In actual operation, there may not necessarily be a fixed number of channels. For example, it is contemplated that there may be 100 channels, 1000 channels, or other amounts of channels.

As shown in FIG. 4, messages that have been exchanged on Channel 1, 401, are illustrated. In an exemplary embodiment of the present invention, messages from multiple users are displayed one above the other with the most recent message appearing on top. This order of displaying messages is merely exemplary. In the illustration shown in FIG. 4, the most recent message is the 1^{st} new message 411. 1^{st} new message 411 is part of a first plurality of messages 421.

As shown in FIG. 4, messages that have been exchanged on Channel 2, 402, are illustrated. In an exemplary embodiment of the present invention, messages from multiple users are displayed one above the other with the most recent message appearing on top. This order of displaying messages is merely exemplary. In the illustration shown in FIG. 4, the most recent message is the 2^{nd} new message 412. 2^{nd} new message 412 is part of a second plurality of messages 422.

As shown in FIG. 4, messages that have been exchanged on Channel 3, 403, are illustrated. In an exemplary embodiment of the present invention, messages from multiple users are displayed one above the other with the most recent message appearing on top. This order of displaying messages is merely exemplary. In the illustration shown in FIG. 4, the most recent message is the 3^{rd} new message 413. 3^{rd} new message 413 is part of a third plurality of messages 423.

As shown in FIG. 4, messages that have been exchanged on Channel 4, 404, are illustrated. In an exemplary embodiment of the present invention, messages from multiple users are displayed one above the other with the most recent message appearing on top. This order of displaying messages is merely exemplary. In the illustration shown in FIG. 4, the most recent message is the 4^{th} new message 4114. 4^{th} new message 414 is part of a fourth plurality of messages 424.

In an exemplary embodiment of the present invention, one channel may be displayed while other channels may be partially or completely not displayed. Thus, for example, Channel 1 may be displayed while Channels 2, 3 and 4 may not be displayed. In this example, when a user receives a new message in Channels 2, 3 and/or 4, the user may wish to see the channel that receive the new message, so that the user can view the new message and possibly response to the new message. Accordingly, an exemplary embodiment of the present invention is now disclosed to enable the viewing (and possible response, of a channel that is not currently being viewed and that has received in the message.

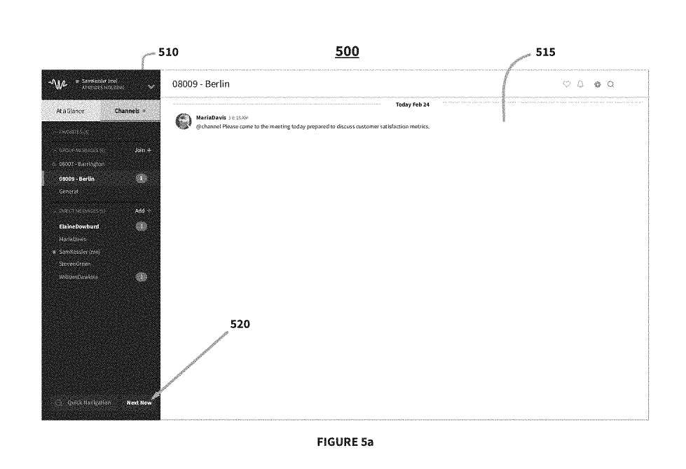

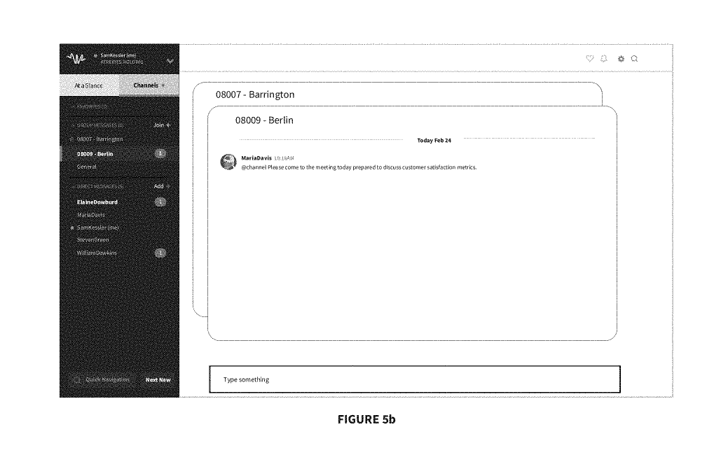

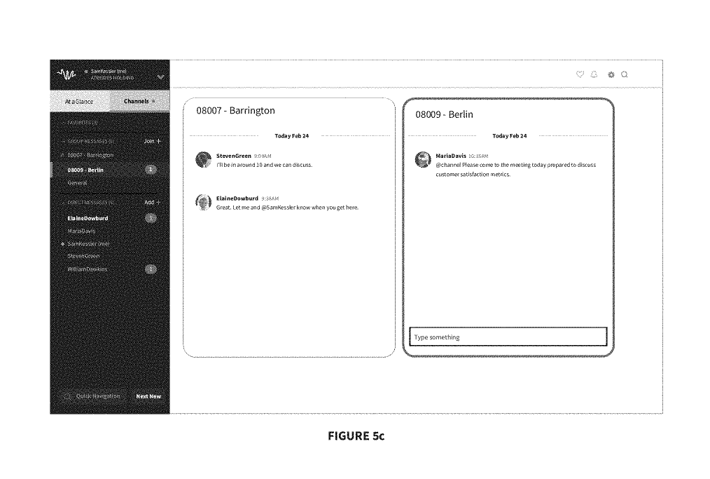

FIG. 5a is a screenshot of an exemplary embodiment of the present invention which illustrates an exemplary mechanism for allowing alternative channels to be viewed. In the illustration shown in FIG. 5, screen 500 has been divided into navigation pane 510 and text pain 515. In text pain 515, messages that are being exchanged over channel are illustrated. In an exemplary embodiment of the present invention, navigation pane 510 allows a user to switch the view illustrated in screenshot 500 from the currently viewed channel (i.e. an “active” channel) to a channel that is not currently being viewed (i.e. an “inactive” channel). For example, navigation pane 510 has categorized channels as being favorites, group messages, and direct messages. The names of respective channels appear under each category. In one exemplary embodiment of the present invention, a user is able to select a specific channel in order to view that channel on his/her screen. Once the channel has been selected, the text that has been exchanged in messages in that respective channel appears in text pain 515. In an exemplary embodiment, the text messages exchanged in each channel are displayed chronologically, one above the other, with the most recent message appearing on top, although this is merely exemplary.

Navigation pane 510 includes next new button 520. Next new button 520 allows a user to shift the view on his display from a currently viewed channel (active) to another channel not currently being viewed (inactive). In an exemplary embodiment of the present invention, the channel which will be viewed once the next new button 520 is selected is a channel that has received a new message and for which the new message (or the new message in its respective channel) has not yet been viewed. When the phrase “not viewed” is used, what may be meant is that none of a channel that has received a new message has been viewed, only portion(s) of the channel that has received a new message has been viewed, and/or the message has been viewed in a way so that response to the new message in its channel is not yet possible.

FIG. 5b and FIG. 5c are further screen shots that illustrate further exemplary embodiments of the present invention. While FIG. 5a illustrates only one channel that is visible, the invention is not limited to allowing channels to be visible in that manner. For example, in FIG. 5b, multiple channels are stacked on top of each other. In FIG. 5c, multiple channels are available for viewing next to each other. In the embodiments illustrated by FIGS. 5b and 5c, channel 8009 may be the “first messaging channel.” Assume that a new message is received in channel 8011 (not shown in FIG. 5b and FIG. 5c). In response to interacting with next new button 520, channel 8011 (which may be the “second messaging channel”) may then become visible (or active). These examples are for illustration purposes only and other screen configurations may be available as well.

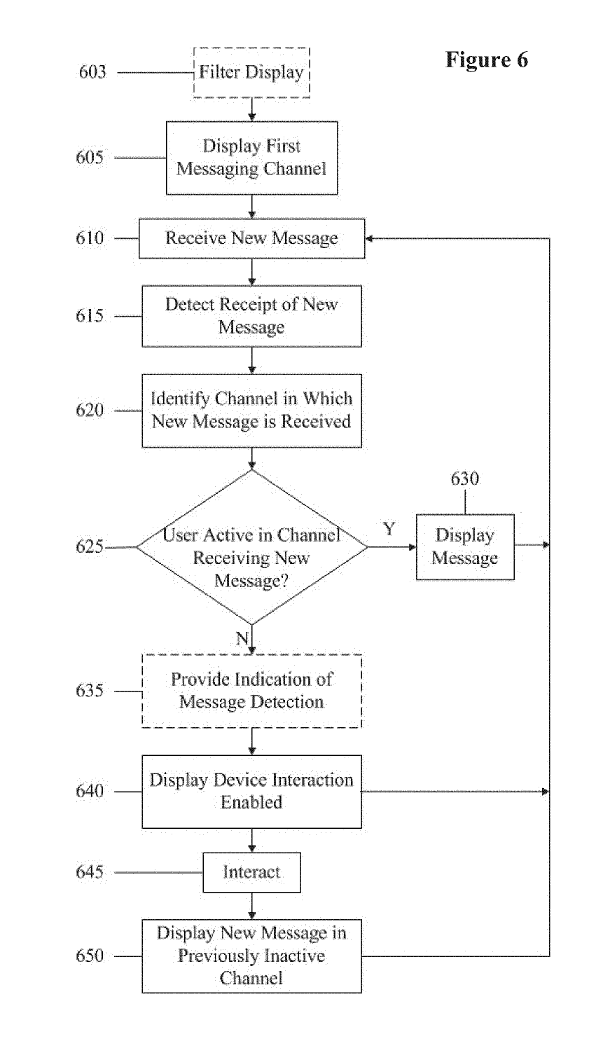

In a further exemplary embodiment of the present invention, if there are multiple channels for which new messages have been received and not yet reviewed, a plurality of rules may apply with regard to the order in which those channels are displayed. Thus, next new button 520 may behave, for example, as a toggle switch; each time next new 520 is selected, another channel with a previously unreviewed new message is displayed according to the predetermined rules. This is more fully described with regard to FIG. 6.

FIG. 6 is a flowchart diagram that illustrates the viewing of channels in accordance with an exemplary embodiment of the present invention. The order in which steps appear in FIG. 6 is for illustrative purposes only. A resequencing of at least some of the step shown in FIG. 6 is contemplated.

Step 603 as an optional step and will be described in further detail below.

At step 605, a 1^{st} messaging channel is displayed. An exemplary 1^{st} messaging channel is illustrated by channel 401 (FIG. 4). What is displayed in channel 1, 401, is a 1^{st} plurality of messages 421 that includes 1^{st} new message 411. In the exemplary embodiment now being described, 1^{st} plurality of messages 421 has been displayed on a display. At step 610, a new message is received. At step 615, receipt of the new message is detected. The new message that has been received and detected is 2^{nd} new message 412 that is a part of 2^{nd} plurality of messages 422 that have been received in channel 2, 402. In the exemplary embodiment being described, Channel 1, 401 has been displayed while channel 2, 402 has either not been displayed or has only partially been displayed.

At step 620, the channel in which the message has been received is identified. In the example now being described, the message has been received within channel 2, 402. At step 625, a determination is made as to whether the user that has received the message in the channel is currently active in that channel. By saying “active”, what is meant is that the channel is being displayed in a manner so that the 2^{nd} new message 412 can be seen (and/or responded to). In the example now being described, the user is not active in channel 2 at the time that the message was received in channel 2 Step 630 is included in the flowchart diagram of FIG. 6 to describe the situation in which a user is active in a channel in which a new message is received. If so, then at step 630 the message is displayed.

At optional step 635, the user that has received the message in the channel is provided an indication that the new message has been detected. The aforementioned indication may be by several methods including a visual indication on a screen, an audible indication, etc. In a further exemplary embodiment, although step 635 is shown prior to step 640, in alternative embodiments step 635 may occur after step 640. In one example, for example, the indication of message detection may not occur until after the interaction which appears at step 645 and is further described below. Furthermore, if the indication associated with message detection does not occur until after step 645, the indication may be as simple as display (or at least partial display) of the newly received message.

At step 640, user interaction with the display device that will be displaying channel 2 is enabled. While step 640 is shown between step 635 and step 645, this is merely exemplary as step 640 may occur at a prior location in the flowchart shown in FIG. 6.

At step 645, the user interacts with the display device. As a result of the interaction, channel 2, 402, for example, will be displayed. While the aforementioned description is with regard to interaction with the display device, the act of display device interaction may be with regard to another I/O device available to user (keyboard, mouse, touchscreen, voice command, etc.)..

At step 650, the new message in the previously inactive channel is displayed to the user. This step entails, for example, displaying channel 2, 402 to a user.

After step 640 or step 650 is completed, operation may proceed to step 610. At that time, for example, channel 2, 402 has now been displayed to a user and a new message is about to arrive on channel 3, 403. Thus, while channel 3, 403 is not visible to the user on their display, the user desires to view new message 413. Operation may then proceed downward through the flowchart diagram illustrated in FIG. 6. Further iterations of the flowchart shown in FIG. 6 (4^{th} new message 414 through an Nth new message) may be displayed responsive to appropriate user interaction.

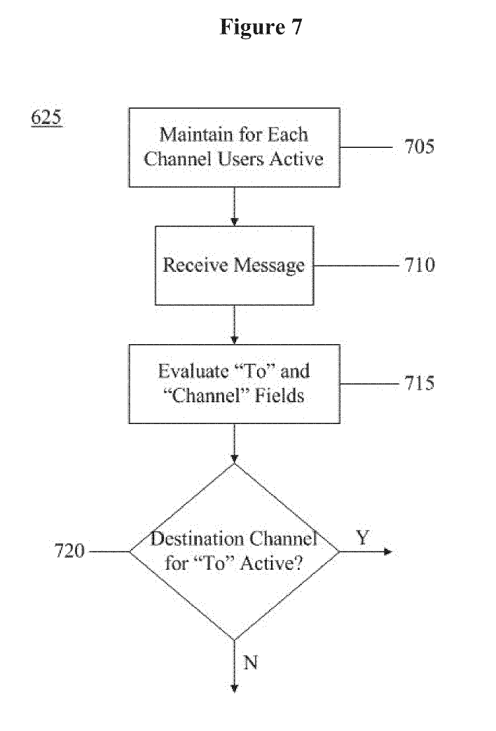

Step 625 of FIG. 6 is further described with reference to the flowchart diagram shown in FIG. 7. At step 705, for each channel, a list of active users is maintained. At step 710, a message is received on one of the channels referenced in step 705. At step 715, the message is evaluated to determine to whom the message has been sent and on what channel the message has been sent. At step 710, the evaluation performed at step 715 is compared with the list of active users for each channel maintained at step 705. If the message has been sent to a user that is not active on a channel, then processing proceeds to step 635. If, however, the message has been sent to a user that is active on a specific channel, then processing proceeds to step 630 (FIG. 6).

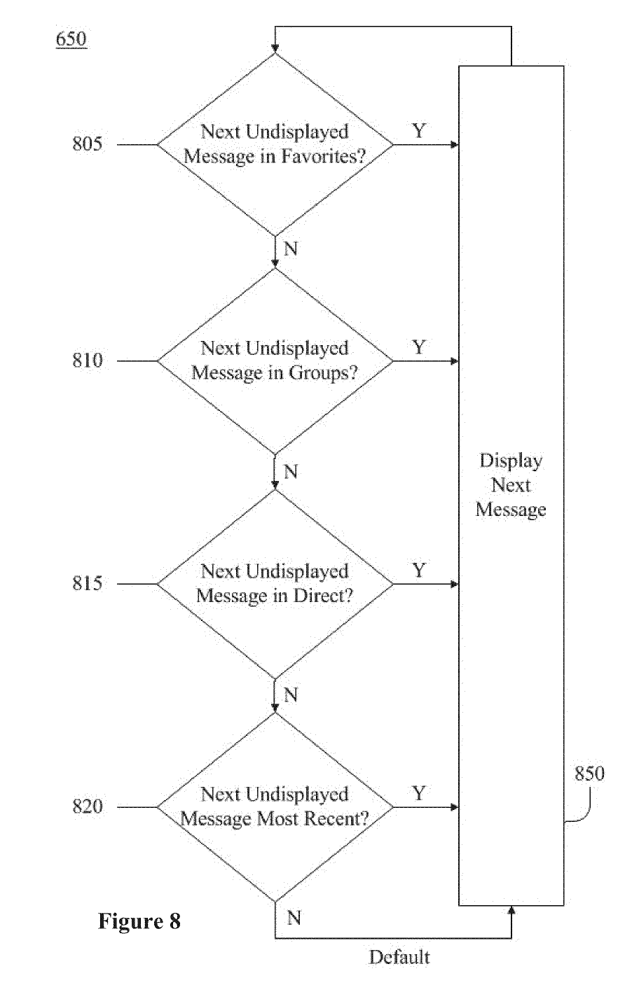

FIG. 8 is a flowchart diagram that further illustrates details of step 650 (FIG. 6). The steps shown in FIG. 8 are with regards to the priority with which channels that have received new messages are made viewable to a user. Thus, for example, a user might be viewing one channel, and multiple messages may be received by that user on multiple unviewed channels. In the exemplary embodiment shown in FIG. 5, next new button 520 is included. As previously described, next new button 520, when interacted with by a user, allows a user to view a channel that has previously not (or partially not) been displayed. If, however, messages are received on multiple channels that have not been viewed, in what order should those channels be displayed to user upon subsequent selection of the next new button 520? A variety of rules are contemplated to answer that question.

Returning to FIG. 6, optional step 603 allows a filter to be used. When a filter is used, selection of the next new button results in viewing of unviewed channels that a) each have a new message; and b) satisfy the requirements of the filter. The filter may designate message source, message content, etc. For example, if the filter designates a message source of “john smith” then selection of the next new button will result in the viewing of unviewed channels with new messages that have originated from “john smith.”

In one exemplary embodiment, new messages in unviewed channels are displayed in the following order, although this is merely exemplary: 1) display messages received in “favorite” designated channels, 2) display messages received in groups (i.e. more than two participants), 3) display messages received as a result of direct messaging, 4) display messages received in chronological order. These exemplary steps are set forth as steps 805, 810, 815, and 820 of FIG. 8.

In a further exemplary embodiment, at least portions of new messages (or certain new messages) may be displayed before they are displayed with previously received messages in the channel in which they are received. Thus, for example, a new message (received in a channel) may quickly appear (in a bubble, for example) without other messages previously received in that channel and then be removed from view in order to “peek” the interest of a user. The user can then go through the steps described above in order to see the new message with other messages in the channel it is received in and/or have the ability to respond to the new message.

Thus, as previously described, as a result of user interaction, newly received messages in unviewed (or partially unviewed) channels are viewed based on user interaction. In an exemplary embodiment, the user interaction is selection of the next new button 520. In a further exemplary embodiment, viewing of new messages received in active channels automatically occurs as a result of interaction with the next new button 520. Thus, the interaction with the next new button 520 and subsequent display of previously unviewed channels that have received new messages occurs as a “1-click” operation of interacting with the next new button 520.

In a further exemplary embodiment of the present invention, a “back” button may also be included. While the next new button allows a user to scroll through various channels according to a set of rules as explained above, a “back” button may allow scrolling to occur in reverse of the scrolling order achieved by selecting the next new button. After viewing five channels with the next new button, those channels may then be viewed in reverse order with the “back” button (for example).

The rules for deciding the order in which channels are viewed by the next new button may be different, depending upon different exemplary embodiments. In one embodiment, the rules are applied to all unviewed channels when the next new button is selected, and the rules continue to be applied to those channels until all of those channels have been viewed. In a further exemplary embodiment, channels with messages that are received after the next new button is pressed are displayed after channels with messages that are received before the next new button is pressed are displayed. In another exemplary embodiment, the viewing rules are reapplied to all unviewed channels that received new messages each time the next new button is selected, and thus the order in which unviewed channels become visible changes with each selection of the next new button. In this embodiment, instead of creating a list in which channels are viewed and adhering to that list, an order preference exists and is reapplied to any unviewed channels at each interaction (i.e. “click”) of the next new button.

The above explanation has included exemplary embodiments to permit display of messages in multiple channels. These embodiments have relied on the use of technology to achieve advantages that are not obtained by the prior art. In particular, by enabling a user to interact with a display, the user is able to at least partially view and respond to messages in multiple channels. By providing a computing apparatus with the above features, messages in multiple channels are readily reviewed and responded to. While the advantages of this technology are easily appreciated when hundreds or thousands of channels are present, those advantages are achieved as well when fewer, and even a handful, of channels are active for a particular user. As a result, a computing device may be operated more efficiently than in the prior art to enable electronic message data to be exchanged between multiple computing devices.

One manner in which a computing device may be operated with greater efficiency is through the ability to see new messages in unviewed channels with less computer interaction than the prior art. As previously explained a “one click” operation enables viewing of such channels. In other embodiments a “at least one click” operation enables viewing of such channels. In any case, the present invention allows for computer operation with greater efficiency because a user is able to identify and traverse channels with new and previously unseen messages. With as few steps as a single click (or other action/interaction), channels may be viewed sequentially (for example) in order to view new and/or unseen messages without spending the time and inefficiency of scanning a list or display of multiple channels (some or all potentially without new messages) to try to determine which channels have new messages.

In an exemplary embodiment of the present invention a computer system may be included and/or operated within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system includes a processing device, a main memory (e.g., read-only memory (ROM), flash memory, dynamic random access memory (DRAM) (such as synchronous DRAM (SDRAM) or Rambus DRAM (RDRAM), etc.), a static memory (e.g., flash memory, static random access memory (SRAM), etc.), and a data storage device, which communicate with each other via a bus.

Processing device represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device may also be one or more special-purpose processing devices such as an application specific integrated circuit (ASIC), a field programmable gate array (FPGA), a digital signal processor (DSP), network processor, or the like. Processing device is configured to execute listings manager logic for performing the operations and steps discussed herein.

Computer system may further include a network interface device. Computer system also may include a video display unit (e.g., a liquid crystal display (LCD) or a cathode ray tube (CRT)), an alphanumeric input device (e.g., a keyboard), a cursor control device (e.g., a mouse), and a signal generation device (e.g., a speaker).

Data storage device may include a machine-readable storage medium (or more specifically a computer-readable storage medium) having one or more sets of instructions (e.g., reference generation module) embodying any one or more of the methodologies of functions described herein. The reference generation module may also reside, completely or at least partially, within main memory and/or within processing device during execution thereof by computer system; main memory and processing device also constituting machine-readable storage media. The reference generation module may further be transmitted or received over a network via network interface device.

Machine-readable storage medium may also be used to store the device queue manager logic persistently. While a non-transitory machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the aforementioned description, numerous details are set forth. It will be apparent, however, to one skilled in the art, that the disclosure may be practiced without these specific details. In some instances, well-known structures and devices are shown in block diagram form, rather than in detail, in order to avoid obscuring the disclosure.

The disclosure is related to an apparatus for performing the operations herein. This apparatus may be specially constructed for the required purposes or it may comprise a general purpose computing device selectively activated or reconfigured by a computer program stored therein. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

1. A method of displaying messages on a display device, said method comprising the steps of:
a) displaying on said display device a plurality of messages including a new message exchanged in a messaging channel while at least partially preventing display of a further pluralities of messages exchanged in further messaging channels, wherein said messaging channel and said further messaging channels are each a respectively different group conversation;
b) detecting receipt of further new messages included in said further pluralities of messages in said further messaging channels, respectively, while display of said further messaging channels that includes display of said further pluralities of messages in said further messaging channels is at least partially prevented;
c) providing a physical indication of said detecting, while displaying said messaging channel that includes displaying said plurality of messages in said messaging channel, and while display of said further messaging channels that includes display of said further pluralities of messages in said messaging channel is at least partially prevented.
d) enabling interaction with said display device;
e) displaying said further messaging channels responsive to said interaction, respectively, wherein said interaction is a repetitive action that results in displaying different ones of said further messaging channels, respectively, wherein when said different ones of said further messaging channels are displayed, what is displayed in each channel of said further messaging channels is: a) a respective one of said further new messages sent in said channel; along with b) yet another message sent in said channel, to which said respective one of said further new messages is a reply.

2. A method according to claim 1, wherein:
step a) includes the step of at least partially preventing display of a yet further plurality of messages exchanged in a yet further messaging channel;
step b) includes the step of detecting receipt of a yet further new message of said yet further plurality of messages without displaying said yet further plurality of messages in said yet further messaging channel;
step c) includes the step of providing said physical indication or a further physical indication of said detecting;
further interaction with said display device is enabled; and
displaying of said yet further message in said yet further channel occurs responsive to said further interaction.

3. A method according to claim 2, wherein said interaction and said subsequent interaction are the same.

4. A method according to claim 2, wherein whether said further new message or said yet further new message are displayed first is according to predetermined criteria.

5. A method according to claim 2, wherein displaying said further message and said yet further message occurs responsive to detection of said interaction and said further interaction, respectively.

6. A method according to claim 1, wherein displaying said further message in said further channel is responsive to said interaction and said further message meeting search criteria.

7. A method according to claim 3, wherein said interaction and said further action are with a common area of display on said screen.

8. A method according to claim 1, wherein step c) occurs with display of a portion of said respective one of said further new messages sent in said channel.

9. A method according to claim 1, further comprising, with or after step e), performing the step of:
f) at least partially preventing display of a previously displayed one of said
further messaging channels.

10. (canceled)

11. Apparatus for displaying messages on a display device, said apparatus comprising:
a memory for storing a first plurality of messages and a further plurality of messages; and
a processor for
a) displaying on said display device a plurality of messages including a new message exchanged in a messaging channel while at least partially preventing display of further pluralities of messages exchanged further messaging channels, wherein said messaging channel and said further messaging channels are each a respectively different group conversation;
b) detecting receipt of further new messages included in said further pluralities of messages in said further messaging channels, respectively, while display of said further messaging channels that includes display of said further pluralities of messages in said further messaging channels is at least partially prevented;
c) providing a physical indication of said detecting, while displaying said messaging channel that includes displaying said plurality of messages in said messaging channel, and while display of said further messaging channels that includes display of said further pluralities of messages in said messaging channel is at least partially prevented;
d) enabling interaction with said display device;
e) displaying said further messaging channels responsive to said interaction, respectively, wherein said interaction is a repetitive action that results in displaying different ones of said further messaging channels, respectively, wherein when said different ones of said further messaging channels are displayed, what is displayed in each channel of said further messaging channels is: a) a respective one of said further new messages sent in said channel; along with b) yet another message sent in said channel, to which said respective one of said further new messages is a reply.

12. Apparatus according to claim 11, wherein:
step a) includes the step of at least partially preventing display of a yet further plurality of messages exchanged in a yet further messaging channel;
step b) includes the step of detecting receipt of a yet further new message of said yet further plurality of messages without displaying said yet further plurality of messages in said yet further messaging channel; step c) includes the step of providing said physical indication or a further physical indication of said detecting;
further interaction with said display device is enabled; and
displaying of said yet further message in said yet further channel occurs responsive to said further interaction.

13. Apparatus according to claim 12, wherein said interaction and said subsequent interaction are the same.

14. Apparatus according to claim 12, wherein whether said further new message or said yet further new message are displayed first is according to predetermined criteria.

15. (canceled)

16. Apparatus according to claim 12, wherein displaying said further message in said further channel is responsive to said interaction and said further message meeting search criteria.

17. Apparatus according to claim 13, wherein said interaction and said further action are with a common area of display on said screen.

18. Apparatus according to claim 11, wherein step c) occurs with display of a portion of said respective one of said further new messages sent in said channel.

19. Apparatus according to claim 11, further comprising, with or after step e), performing the step of:
f) at least partially preventing display of a previously displayed one of said further messaging channels.

20. (canceled)

21. A method according to claim 1, wherein displaying said further new messages is performed without entering identification of any of said channels.

22. (canceled)

23. A method according to claim 1, wherein said interaction is performed without selecting from a fixed list of said channels.

24. Apparatus according to claim 11, wherein displaying said further new messages is performed without entering identification of any of said channels.

25. (canceled)

26. Apparatus according to claim 11, wherein said interaction is performed without selecting from a fixed list of said channels.

27. A method according to claim 1, wherein said yet another message is sent in said channel one of before said respective one of said further new messages is sent in said channel; and after said respective one of said further new messages is sent in said channel.

28. Apparatus according to claim 11, wherein said yet another message is sent in said channel one of before said respective one of said further new messages is sent in said channel; and after said respective one of said further new messages is sent in said channel.

29. A method according to claim 1, wherein content of at least one of said further new messages is entered into a text entry bar separate from said yet another message and from there is transmitted to said respective one of said channels.

30. Apparatus according to claim 11, wherein content of at least one of said further new messages is entered into a text entry bar separate from said yet another message and from there is transmitted to said respective one of said channels.

31. A method according to claim 1, wherein each respectively different group conversation has at least two participants.

32. A method according to claim 1, wherein said respective one of said further new messages and said reply are sent by a same member of said channel.
